(19) United States
(12) Patent Application Publication
(10) Pub. No.: US 2013/0322050 A1
(43) Pub. Date: Dec. 5, 2013

(54) MODULAR CIRCUIT BREAKER, KIT, AND METHODS OF MANUFACTURE AND ASSEMBLY

(71) Applicants: Daniel Douglas David, Portland, OR (US); John Lawrence Staylor, Tualatin, OR (US)

(72) Inventors: Daniel Douglas David, Portland, OR (US); John Lawrence Staylor, Tualatin, OR (US)

(21) Appl. No.: 13/485,332

(22) Filed: May 31, 2012

(51) Int. Cl. H01H 71/08

(52) U.S. Cl. CPC H01H 71/08
USPC 361/824

(57) ABSTRACT

Circuit protection products such as a circuit breaker include housings configured for modular assembly with selected ones of a plurality of separately provided and differently configured terminal studs. The nonconductive housing includes at least one aperture, and each of the plurality of differently configured terminal studs includes a common universal mounting base configured for one of press fit engagement or threaded engagement with the nonconductive housing when the universal mounting base is received in the aperture.

### BACKGROUND OF THE INVENTION

The field of the invention relates generally to circuit protection products including terminal studs and methods of manufacture, and more specifically to circuit breaker products for protecting electrical circuitry.

A variety of circuit protection products are known that include terminal studs for establishing input and output electrical connections to line side and load side circuitry in an electrical power systems. Examples of such circuit protection products include terminal blocks and power distribution modules that may include fuses and/or circuit breaker components to interrupt electrical connection between the line side circuitry and load side circuitry and electrically isolate the line side from the load side in response to problematic circuit conditions that may otherwise cause damage to the load side circuitry. Additionally, fuses may be used apart from such terminal blocks with fuseholders and accessories including terminal studs for making electrical connections to circuitry, and circuit breaker products including terminal studs may also be used apart from any terminal blocks or power distribution modules. Such terminal stud connections are convenient in automotive applications, marine applications, and recreational vehicle applications, among others, for quickly establishing the electrical connections with ring terminals and the like.

The proliferation of such circuit protection devices has resulted in considerable variation in specifications for the devices insofar as the terminals are concerned. In the example of a circuit breaker, different amperage ratings can require different terminal studs. Even for products of the same amperage, different threaded stud diameters are sometimes desired. Additionally, metric threaded studs are sometimes desired and standard (or English) threads are other times desired. Occasionally, terminal studs are not desired at all. To accommodate the various terminal options, different versions of the circuit breakers are often provided including different types of terminals. From a manufacturing perspective, this result in relatively customized versions of otherwise similar products and is less than ideal. From a distribution perspective, inventory costs can be high to fully stock all of the available versions having different terminal options.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is an exploded view of an exemplary circuit breaker device.

FIG. 2 is a perspective assembly view of a circuit breaker device similar to that shown in FIG. 1 but adapted for use with interchangeable terminal studs.

FIG. 3 illustrates a first exemplary terminal stud for the circuit breaker shown in FIG. 2.

FIG. 4 illustrates a second exemplary terminal stud for the circuit breaker shown in FIG. 2.

FIG. 5 illustrates a third exemplary terminal stud for the circuit breaker shown in FIG. 2.

FIG. 6 illustrates a fourth exemplary terminal stud for the circuit breaker shown in FIG. 2.

FIG. 7 illustrates a fifth exemplary terminal stud for the circuit breaker shown in FIG. 2.

FIG. 8 is a top plan view of a first exemplary configuration of the circuit breaker device shown in FIG. 2.

FIG. 9 is a top plan view of a second exemplary configuration of the circuit breaker device shown in FIG. 2.

FIG. 10 is a top plan view of a third exemplary configuration of the circuit breaker device shown in FIG. 2.

FIG. 11 is a top plan view of a fourth exemplary configuration of the circuit breaker device shown in FIG. 2.

### DETAILED DESCRIPTION OF THE INVENTION

Exemplary embodiments of modular circuit protection products, including circuit breaker products, are described hereinbelow that involve fewer component parts to meet the varying needs and desires of the marketplace. By providing a relatively small number of modular parts, including interchangeable terminal studs of varying types, customized terminal options may be rather easily accommodated with a reduced inventory of parts and with reduced costs.

While the discussion below is provided in the context of a circuit breaker device, the benefits of the invention are not necessarily limited to circuit breaker devices. Rather, the benefits of the invention may accrue more generally to circuit protection devices of all kinds, including, in addition to circuit breakers, fuse holder devices, terminal block devices, power distribution devices, and other equivalent devices associated with protection of electrical circuitry in similar applications. Method aspects will be in part apparent and in part specifically discussed in the description below.

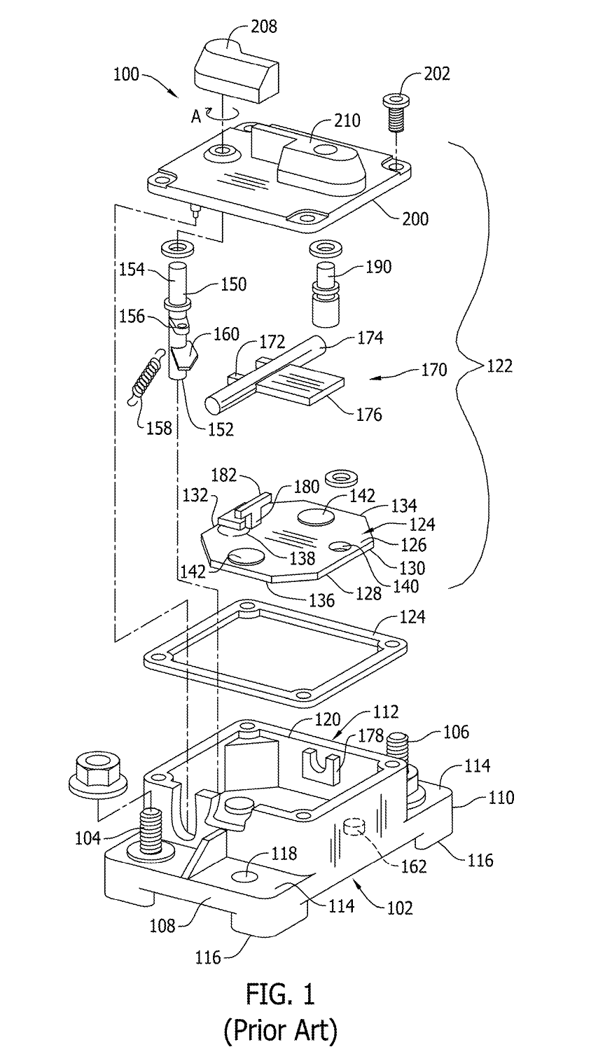

FIG. 1 is an exploded view of a conventional circuit breaker device 100. In the example shown, the circuit breaker device 100 is a surface mount high-amp manual reset circuit breaker. The circuit breaker device 100 includes a nonconductive base or housing 102 and a pair of terminal studs 104, 106 extending from the housing 102.

In the embodiment shown, the housing 102 includes a first terminal section 108 including the terminal stud 104, a second terminal section 110 including the terminal stud 104 and a circuit protector housing 112 extending between the first and second terminal sections 110 and 112. In the example shown, the housing 102 is integrally formed to include the sections 108, 110, and 112 in a monolithic or single piece construction. The housing 102 may be fabricated from heavy duty plastic according to known techniques. In other embodiments, the terminals sections 108, 110 and the circuit protector housing 112 may be fabricated from one or more pieces that are assembled to one another.

The terminal sections 108, 110 and 112 generally include an opposing top side or surface 114 and a bottom side or surface 116, and in the illustration of FIG. 1 the terminal studs 104, 106 extend from the top side or surface 114. The terminal stud 104, 106 are mounted on opposite sides of the circuit protector housing 112. Thus, the terminal stud 104, 106 may be respectively accessed on either side of the circuit protector housing 112. Variations in the locations of the terminal studs 104, 106 are possible from that shown in FIG. 1.

The bottom surface 116 of the housing 102 may be seated upon a support structure and the housing 102 may be attached to the support structure with a fastener (not shown in FIG. 1) and mounting holes 118 provided in each respective terminal section. The circuit protector housing 112 is raised from the terminal sections 108, 110 and defines a receptacle 120 for a circuit breaker assembly 122 as described below.

The circuit breaker assembly 122 includes a bimetallic, bistable, thermally activated element 124 that is mountable in the receptacle 120. The bistable mechanical element is fabricated to exhibit a predetermined overcurrent snap action. The bistable element 124 is shown in FIG. 1 in a non-overload condition wherein it exhibits a first relatively flat and horizontal position as shown. When there is an overload, the bistable element 124 heats up and deflects to snap into a second position wherein a portion of the element 124 is deflected out of the horizontal plane.

The bimetallic bistable element 124 may be fabricated from a known thermally reactive composite alloy. In the example shown, the bistable element 124 includes a top surface 126, a bottom surface 128, a fixed end 130, a moveable end 132 and lateral sides 134, 136. A weld disc and a preferably high silver content contact 138 are welded to the moveable end 132 of the element. The weld disc is attached to the top surface 122 and the contact 138 to the bottom surface 128. Both the contact 138 and the weld disc extend inwardly from the top edge of the end 132 and are positioned in the center of the end 132. Variations are possible, however.

The end 130 includes a hole 140. Adjacent each side 134 and 136 is a dimple 142. The dimples 142 are concave on the top surface 122 and convex on the bottom surface 128. The length of the bistable element 124 in one example is about 1 5/16 inches to about 1½ inches and the width is about 1 inch to about 1¼ inches. Thus, the width in these examples is greater than about ½ the length. Variations are possible.

The bistable element 124 may be accurately calibrated and mass produced, without having to individually calibrate the assembled device 100. In other embodiments, however, the device 100 may include a disc construction which requires individual calibration of the device.

The breaker assembly 122, also includes within the receptacle 120, and in addition to the bistable element 124, a rotatable non-conductive insulating shaft 150. A first end 152 of the shaft 150 is inserted into a blind hole formed in the base of the receptacle 120 and its other end 154 extends outside of the receptacle 120.

The shaft 150 further includes a first spring attaching bar 156 integrally extending therefrom. This bar 156 is used to connect one end of an extension spring 158. Spaced a predetermined distance below the first bar is a non-conductive heat resistant second extension bar or extension blade 160. The second extension blade 160 extends a predetermined distance substantially radially from the shaft 150.

The extension blade 160 is spaced a predetermined distance above the base of the receptacle 120. The size and length of the extension blade 160 is determined so that it can fit between the bistable element contact 138 and a terminal contact in the receptacle 120 to maintain an electrical insulation therebetween and to keep the two contacts separated if desired.

The bistable element 124 is mechanically staked at the end 130 to a terminal contact 162 in the receptacle 120. The terminal contact 162 is further associated with the terminal stud 106. The bistable element 124 is sized and the rotatable shaft 150 is mounted in the receptacle 120 such that the other end 132 of the bistable element 124 is adjacent to the rotatable shaft 150. The mounting height of the bistable element 124 in the receptacle 102 is such that the contact 138 is generally in the same plane as the extension blade 160 of the shaft 150. The flat side surface of the extension blade 160 rests against the end surface of the contact 138 when the breaker circuit is in its closed position.

The extension blade 160 is urged towards the contact 138 by the extension spring 158 which has its other end connected to one of the sidewalls defining the receptacle 120. A stationary contact associated with the terminal stud 104 is situated in the receptacle 120 just below the contact 138 of the bistable element 124, and also adjacent to the rotatable shaft 150 and below the extension blade 160. The extension blade 160 is such that it extends at least to the center of the element contact 138 and the stationary contact when the circuit breaker is in its open position.

The breaker assembly 122 further includes a lift arm 170 including fingers 172, a bar 174, and plate 176. Bar 174 rests in slots or cradles 178 formed in opposing sidewalls of the receptacle 120. A lift bracket 182 is attached to the bimetallic bistable element 124. The lift bracket 182 has arms 182 which normally rest on the fingers 172 of lift arm 170.

The breaker assembly 122 also includes a push-to-trip button 190 resting against lift arm 170.

A nonconductive or insulating cover 200 is provided and attaches to the upper edge of the receptacle 120 via rivets 122 or other known fasteners. A seal 204 extends between the upper edge of the receptacle 120 and the cover 200. End 154 of the shaft 150 extends through the cover 200 for a predetermined distance. Another seal 206 aids in the sealing of the shaft 150 from the exterior of the housing cover 200.

A manual reset lever 208 is pressure fitted onto the shaft end 154. When the circuit breaker is open, the reset lever 208 is rotated or pivoted in the direction of arrow A for a predetermined distance and establishes a trip position. The rotated reset lever 208 in the trip position is a visual indication that the breaker assembly must be reset. The resetting must be done manually. When the reset lever is pivoted to its trip position the circuit of the circuit breaker is opened to prevent electricity from passing therethrough. After the overload condition ceases and a predetermined time has passed the reset lever handle 208 can be returned manually to return the circuit breaker to its closed circuit position.

The push-to-trip button 180 is slidably mounted in raised portion 210 of cover plate 200. Push-to-trip button 190 may be used to manually place the breaker in an open circuit condition as described in more detail below.

In operation, the high-amp circuit breaker is normally in its closed position completing an electrical connection between the stud terminals 104, 106 and through the bistable element 124. The spring 158 is in its extended position urging the extension blade 160 towards and against the element contact 138. The terminal contact in the receptacle 120 and the element contact 138 are in electrical contact with each other. When there is a predetermined overload in a circuit connected via terminal studs 104 and 106, the bistable element 124 snaps its end 132 to the second position wherein the contact 132 is raised a predetermined distance above the terminal contact and the blade 160 is then moved between the two contacts. The blade 160 in this position electrically insulates the two contacts from each other and prevents contact 138 from contacting the terminal contact in the receptacle 120 until the breaker is reset. When there is an overload, the reset lever 208 is also moved on the surface of the cover 200, and may be rotated to a position pointing to a label on the cover 200 to indicate the circuit breaker needs resetting. However, even without the indication, it is readily observable from the position of the lever 208 that the breaker needs to be reset.

To reset the breaker, lever 208 is merely turned back to its original position such that the extension blade 160 is moved from between the element contact 138 and the terminal contact in the receptacle. The spring 158 is extended as this is done. As soon as the extension blade 160 is removed from between the contacts 138 and the corresponding contact in the receptacle 120, the contact 138 returns to its closed position and the extension blade 160 contacts the side of the element contact 138 as shown.

During manual tripping, the push-to-trip button 190 is depressed which forces plate 176 downward and rotates the lift arm 170 about bar 174. This raises fingers 172 of lift arm 170 which also raises arms 182 of lift bracket 182 pulling one end of thermal bistable element 124 in an upward direction. This allows blade 160 to move between contact 138 and the contact in the receptacle and open the circuit through the bistable element 124.

The stud terminals 104 and 106 are built-in to the housing 102 via overmolding techniques and cannot be removed. Thus, if for example the terminals 104 and 106 include English threads when metric threads are desired, the device 100 generally cannot be used. In such a case, the manufacturer of the device 100 would provide another version of the device including essentially the same breaker assembly but including stud terminals with metric threads. Still other variations in desired terminals has conventionally led to still other versions of circuit breaker devices having otherwise similar breaker assemblies but with stud terminals having different diameters. Different amperage requirements can lead to still other different versions of the devices using different terminals.

Manufacturing a large number of customized versions of otherwise similar circuit breaker devices presents manufacturing difficulties and costs that are perhaps better avoided. From a distribution perspective, inventory costs can be high to fully stock all of the available versions having different terminal options. A simpler, less expensive manufacturing and distribution process is desired.

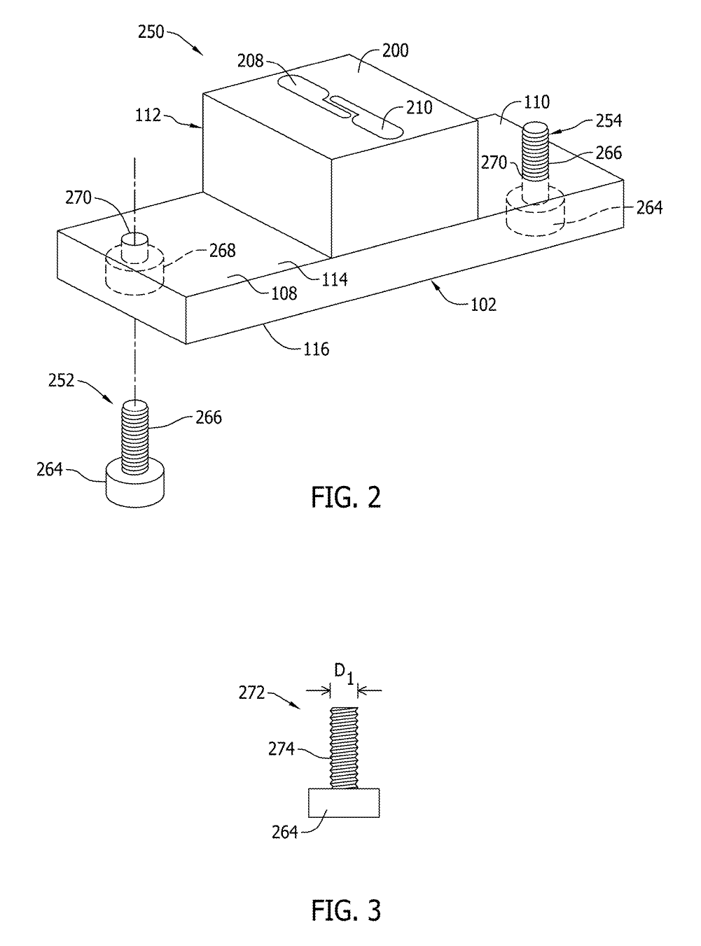

FIG. 2 is a perspective assembly view of a circuit breaker device 250 that is similar in many aspects to the circuit breaker 100 shown in FIG. 1. Like elements of the devices 250 and 100 are therefore indicated with like reference characters in the drawings.

Unlike the device 100 (FIG. 1) wherein the terminals 104 and 106 are built-in to the housing 102 via overmolding process and the like, the device 250 includes separately provided and interchangeable terminal studs 252, 254 that may be assembled to and removed from the housing 102. As such, the housing 102 including the breaker assembly 122 (FIG. 2) may be selectively assembled with different types of terminal studs easily and conveniently at each of the manufacturer, distributor and end user levels. Different types of terminal studs may therefore be utilized without having to manufacture customized versions of the entire device 250. Also, the device 250 may be used without terminal studs at all simply by not installing the terminals 252, 254 or by removing them. The device 250 may also be easily modified for different uses by removing the terminals 252, 254 and replacing them with differently configured terminals. As such, the device 250 can be retrofit with different terminals for continued use, rather than the end user having to purchase an entirely new device.

As best shown in FIG. 2, the terminal stud 252 includes a universal mounting base 264 and a threaded terminal portion 266. The mounting base 264 has a greater diameter than the threaded terminal portion 264, and may be configured for press fit insertion into the housing 102 or configured for threaded engagement with the housing 102. Regardless, the mounting base 264 is designed to facilitate its installation to the housing 102 after the housing is formed and the breaker assembly is completed, as well as to facilitate its removal from the housing 102 when desired. While the mounting base 264 is illustrated as having a round shape, other geometric shapes are possible, including but not limited to polygonal shapes having a plurality of distinct sides.

In the example shown, the mounting base 264 is received in a corresponding aperture 268 formed in the terminal section 108 of the device housing 102, and the threaded terminal portion 266 is extended through an aperture 270 formed in the terminal section 108. The aperture 268 is complementary in size and shape to the outer profile of the terminal mounting base 264, and the aperture 270 is generally complementary in size and shape to the threaded terminal portion 264. The aperture 268 may include threads, a threaded insert, or a releasable retaining feature facilitating press fit engagement of the terminal stud 252 to the housing 102. In exemplary embodiments, locking tabs, stop features and other equivalent features known in the art may be utilized to facilitate a releasable, snap-fit engagement of the terminal stud 252 via the mounting base 264. While an ability to remove the stud 252 is desirable, it is not necessary in all embodiments and thus the mounting base 264 may optionally be configured for engagement (e.g., by press fit insertion), but not for removal once installed.

By configuring the housing 102 and the mounting base 264 with complementary shapes, a universal mounting arrangement is made possible wherein different terminal types can be interchangeably installed in the housing 102 so long as the differently configured terminal studs include a common mounting base 264. This provides for much versatility in configuring the device 250 with different terminal options. That is, the device 250 can quickly and easily be configured with different types of terminals, can easily be modified to include different types of terminals, or can easily be provided (or modified) for use without any stud terminals.

The terminal stud 252 in the example shown is inserted into the housing terminal section 108 from the bottom side or surface 116 of the housing 102, and the threaded terminal portion 266 extends above and projects from the top side or surface 114 of the housing 102. In another contemplated embodiment, the terminal 252 could be inserted into the housing terminal section 108 from the top side 116. The terminal 252 may be installed at the manufacturer level, at the distributor level, or at the end user level.

In the example shown in FIG. 2, the terminal stud 254 is substantially identical to the terminal stud 252 and is installed in the same manner as the terminal stud 254. Thus, for example, if the stud 252 includes English threads in the threaded terminal portion 266 the stud 254 may likewise include English studs. As another example, the threaded terminal portions 266 of the studs 252, 254 may be configured for the same amperage rating and may have identical diameters. Where desired, however, the terminals 252, 254 need not be configured to be the same. For example, the terminals 252, 254 can include different types of threads and may have different diameters in the respective threaded terminal portions 264.

FIGS. 3-7 illustrate differently configured terminal studs that may be interchangeably used with the device 250. FIGS. 3-7 are non-limiting examples illustrating the versatility of the types of terminals useable with the device 250.

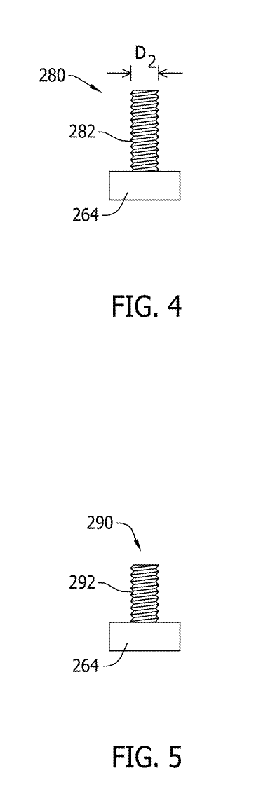

FIG. 3 illustrates a terminal stud 272 having the universal mounting base 264 and a threaded terminal portion 274 having a first diameter D₁. FIG. 4 illustrates a terminal stud 280 having the universal mounting base 264 and a threaded terminal portion 282 having a second diameter D₂. In the examples shown in FIGS. 3 and 4, the second diameter D₂ is larger than the first diameter D₁. Other terminal studs could likewise be provided having greater or smaller diameters. Because of the universal mounting base 264, however, either of the terminals 272 or 280 may be assembled to the housing 102 of the device 250 to establish electrical connection through the breaker assembly.

FIG. 5 illustrates a terminal stud 290 having the universal mounting base 264 and a threaded terminal portion 292 having a shorter axial length than the terminals 272 and 280 shown in FIGS. 4 and 5. Because of the universal mounting base 264, however, the terminal 290 may be easily assembled to the housing 102 to provide a different terminal structure. Similar terminal studs could be provided with greater and lesser axial lengths to provide still further options, and for any given length of the threaded terminal portions, the diameter could be varied in the threaded portions as shown in FIGS. 3 and 4.

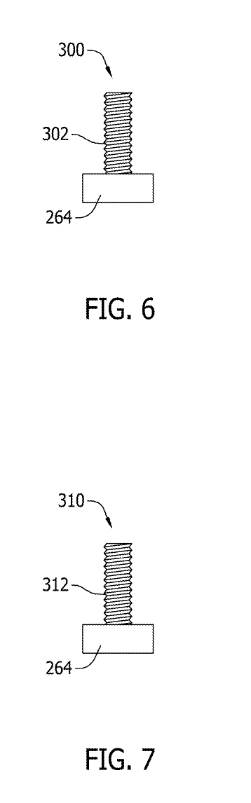

FIG. 6 illustrates a terminal stud 300 having the universal mounting base 264 and a threaded terminal portion 302 having a first thread type such as an English-type thread. FIG. 7 illustrates a terminal stud 310 having the universal mounting base 264 and a threaded terminal portion 312 having a second thread type such a metric-type thread. Other terminal studs could likewise be provided having different types of threads. Because of the universal mounting base 264, however, either of the terminals 300 or 310 may be assembled to the housing 102 of the device 250 to establish electrical connection through the breaker assembly.

As should be evident from FIGS. 3-7, a large number of differently configured terminal studs having a common mounting base 264 can be provided for interchangeable use with the device 250. While exemplary configurations of the terminal threaded portions are described having different diameters, different axial lengths, and different types of threads are shown and described, it is contemplated that still other parameters of the threaded terminal portions may be varied to provide still other terminal options.

Also, while a single mounting base 264 has been shown and described in the examples discussed above, more than one type of mounting base 264 may be utilized to provide still other variations and ensure that the terminal studs are used compatibly with the circuit breaker assembly in the device 250. For example, different mounting bases may be utilized with different amperage ratings of the circuit breaker assembly to ensure that selected terminal studs match the breaker assembly. By providing different mounting bases, terminal studs configured for one amperage rating may not be used with circuit breaker assemblies having another amperage rating, or vice versa.

As another example, one mounting base could be used with English-type threaded terminals while another mounting base could be used with metric-type threaded terminals. Thus, once one becomes familiar with the mounting base scheme utilized, a user could recognize and distinguish English threaded terminals from metric threaded terminals by looking at the mounting bases. Of course, it is possible that the English and metric terminals in this example could be universally used in the same device housing 102 even though different mounting bases are provided in the terminals. Strategic selection and coordination of mounting bases with the configuration of the housing apertures receiving them may provide still further variations of modular component constructions that may be interchangeable used in combination.

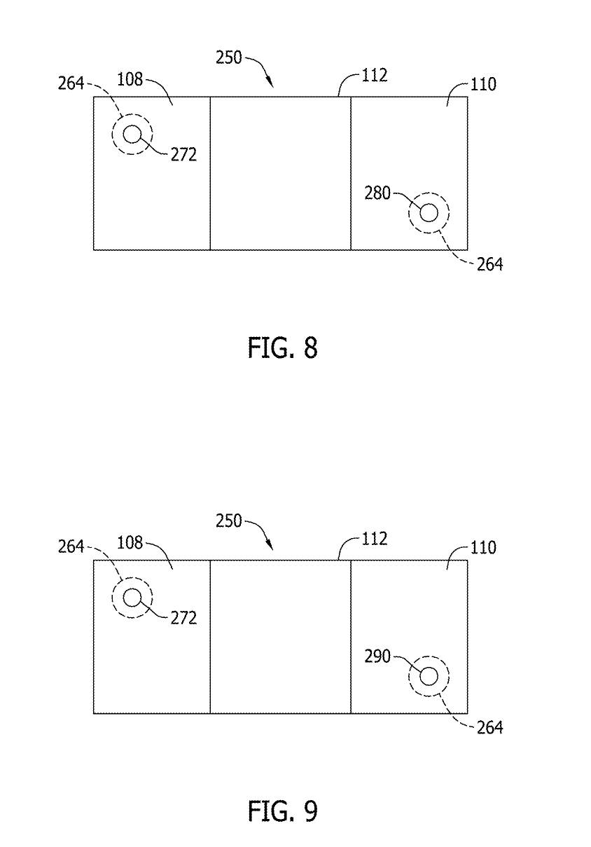

FIGS. 8-10 illustrate various configurations of the device 250 including different terminal options.

FIG. 8 illustrates the device 250 including the terminal stud 272 on one end and the terminal stud 280 on the other. Thus, line and load connections to the breaker assembly may be established using different diameters of terminal studs in the threaded portions. In other embodiments, a pair of terminal studs 272 could be used or a pair of terminal studs 280 could be used so that the diameters of the studs on each end of the device is the same. Also, instead of the studs being located on the opposing ends of the device, the studs could be located on the same end or in other alternative locations on the device.

FIG. 9 illustrates the device 250 including the terminal stud 272 on one end and the terminal stud 290 on the other. Thus, line and load connections to the breaker assembly may be established using terminal studs having different axial lengths in the threaded portions. In other embodiments, a pair of terminal studs 290 could be used so that the axial length of the stud threaded portions on each end of the device is the same. Instead of the studs being located on the opposing ends of the device, the studs could be located on the same end or in other alternative locations on the device.

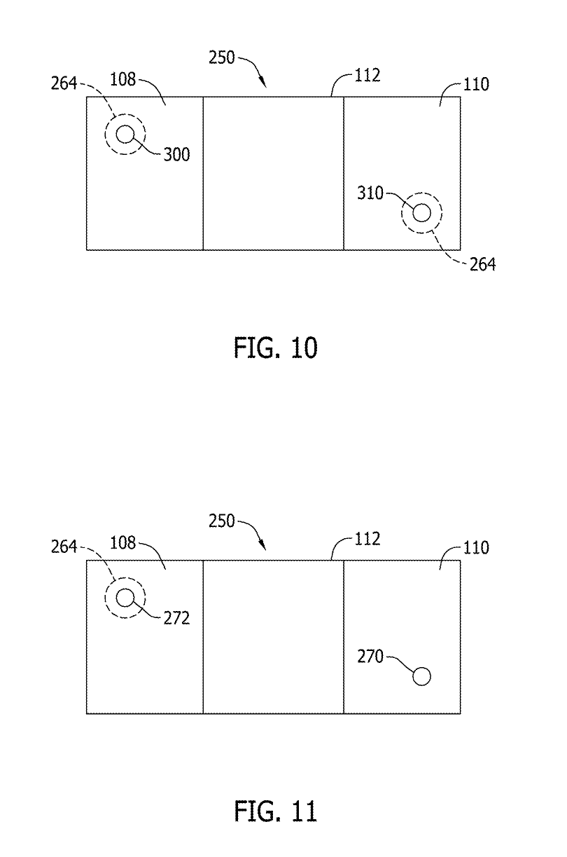

FIG. 10 illustrates the device 250 including the terminal stud 300 on one end and the terminals stud 310 on the other. Thus, line and load connections to the breaker assembly may be established using terminal studs having different types of threads in the threaded portions. In other embodiments, a pair of terminal studs of the same thread type could be used on each end of the device 250. Instead of the studs being located on the opposing ends of the device, the studs could be located on the same end or in other alternative locations on the device.

FIG. 11 is a top plan view of a fourth exemplary configuration of the circuit breaker device shown in FIG. 2. The device 250 includes the terminal stud 272 on one end and no terminal stud on the other. That is, on the terminal section 110 of the housing 102, no terminal stud is provided and the aperture 270 through which a threaded portion of a stud may extend is empty. The stud 272 could located in another location on the device rather than the end as shown. In another embodiment, no terminal stud may be provided on the device 250, whether on the opposing ends or elsewhere.

Because of the universal mounting base configuration described above, one can easily configure the device 250 as shown in FIGS. 8-11 by selecting the desired terminal studs and installing them (or not installing them at all). Additionally, it is possible to reconfigure any of the devices shown in FIGS. 8-11 to one of the other configurations shown by removing and replacing one type of terminal stud with another, or by removing and not replacing one of the terminal studs.

The modular components described may be provided in the form of a kit including modular circuit protector devices such as the circuit breaker device 250 described above, and various differently configured terminal studs. The differently configured terminal studs, by virtue of the universal mounting base arrangement may be used to selectively assemble and disassemble the device to include different terminal options (including no stud terminals on either end of the device). The device may be initially configured for ideal set up either at the manufacturer level, the distributor level or the end user level. The device may be modified or reconfigured for different terminal options either at the manufacturer level, the distributor level or the end user level. The device can be retrofit with different terminal options at the distributor level or the end user level. The differently configured terminals can be sold, purchased or otherwise provided separately from the device 250.

While an exemplary type of circuit breaker device 250 has been shown and described, it is understood that the concepts described herein apply to other types of circuit breakers including different breaker assemblies, different housing configurations, and different terminal locations. Moreover, the concepts described herein apply to other types of circuit protection devices involving circuit breakers or fuses providing circuit protection capability. The fuses and circuit breakers may be associated with terminal blocks and power distribution modules, or may be used as stand alone circuit protection devices. In the case of fuses, the modular terminal studs including the universal mounting base may be implemented in fuse holder devices and other accessories familiar to those in the art.

A method of assembling a circuit protection device such as the device 250 described above includes the steps of providing the housing including the circuit breaker assembly, providing the plurality of differently configured terminal studs each having the universal mounting base as described above, and selecting desired ones of the differently configured terminal studs for use as the line and load side terminals of the device. Once the terminals are selected, they method may also including assembling the selected terminal studs to the device with press fit or threaded engagement as described above. Such steps could be performed entirely at the manufacturer level, entirely at the distributor level or entirely at the end user level.

Providing the housing and the plurality of differently configured terminal studs may be made at the manufacturing level, the distributor level or the end user lever. For the purposes of the present disclosure, the providing steps only require that the modular component parts (i.e., the housing including the breaker assembly) and the terminal studs be made available for selection and assembly into a desired configuration of the device.

Likewise, the step of selecting desired ones of the differently configured terminal studs could be performed by the manufacturer, a distributor, or the end user. Additionally, for the purposes of the present disclosure, the end user or purchaser may select desired ones of the differently configured terminal studs from a distributor or manufacturer, and in such instances the distributor and/or manufacturer shall be deemed to make a corresponding selection when fulfilling the requested configuration and supplying the configured device.

If desired, the method may also include removing the selected terminal studs and replacing them with different terminal studs, or removing at least one of the terminal studs without replacing it. Such steps could be performed at the manufacturer level, entirely at the distributor level or entirely at the end user level.

The benefits of the invention are now believed to have been amply demonstrated by the exemplary embodiments disclosed.

An embodiment of a circuit protection product has been disclosed including a nonconductive housing and a plurality of differently configured terminal studs, wherein the nonconductive housing is configured to interchangeably accept all of the differently configured ones of the plurality of conductive terminal studs.

Optionally, the plurality of conductive terminal studs includes a universal mounting base and a threaded portion projecting from the universal mounting base. The nonconductive housing may include at least one aperture dimensioned to accept the universal mounting base after the nonconductive housing is formed. The nonconductive housing may be configured for threaded engagement with the universal mounting base. The nonconductive housing may be configured for press fit engagement with the universal mounting base.

The nonconductive housing may further include a top surface and a bottom surface opposing one another, and wherein the at least one aperture is accessible from one of the top and bottom surfaces. The nonconductive housing may include a first terminal section, a second terminal section, and a circuit protection housing section between the first terminal section and the second terminal section, and the at least one aperture may include a first aperture located in the first terminal section and a second aperture located in the second terminal section.

The circuit protection product may further include a circuit breaker assembly located in the circuit protection housing section. The circuit breaker assembly includes a bistable element. The circuit breaker assembly may include a trip element, the trip element extending external to the circuit protection housing section and operable by a user to deflect the bistable element. The circuit breaker assembly may include a reset element, the reset element extending external to the circuit protection housing section and operable by a user on an exterior surface of the circuit protector housing section to reset the bistable element.

Another embodiment of a circuit breaker device has been disclosed including a nonconductive housing, a circuit breaker assembly situated in at least portion of said housing, and terminals for establishing an electrical connection through the circuit breaker assembly, wherein the terminals are separately provided from the nonconductive housing and include at least one universal mounting base receivable in an aperture in the housing and engageable to the housing with one of a press fitted engagement and a threaded engagement.

Optionally, the at least one universal mounting base is removable from the housing. The terminals may include at least one threaded terminal portion extending from the universal mounting base. The terminals may include a plurality of differently configured terminals each including a universally mounting base and a threaded terminal portion, the threaded terminal portions in each of the differently configured terminals including at least one of different diameters of the threaded terminal portions, differently configured threads in the threaded terminal portions, and different axial lengths in the threaded terminal portions.

The nonconductive housing may include a top surface and a bottom surface opposing one another, and the aperture in the housing may be accessible from one of the top and bottom surfaces to receive the universal mounting base. The nonconductive housing may include a first terminal section, a second terminal section, and a circuit protection housing section between the first terminal section and the second terminal section.

The circuit breaker assembly may include a bistable element and a trip element, the trip element operable by a user to deflect the bistable element. The circuit breaker assembly may also include a reset element, the reset element operable by a user to reset the bistable element.

Another embodiment of a circuit breaker device kit has been disclosed, the kit including at least one nonconductive housing including a circuit breaker assembly, and a plurality of differently configured terminal studs, each of the plurality of differently configured terminal studs including a common universal mounting base configured for one of press fit engagement or threaded engagement with the nonconductive housing, wherein the common universal mounting base provides interchangeable assembly of any of the plurality of differently configured terminal studs with the housing.

Optionally, the plurality of differently configured terminal studs may be configured with at least one of different diameters, differently configured threads, and different axial lengths. The circuit breaker assembly may be resettable and may be manually trippable.

Another embodiment of a circuit breaker device has been disclosed including a nonconductive housing including a circuit breaker assembly, wherein the nonconductive housing is configured for assembly with selected ones of a plurality of separately provided and differently configured terminal studs.

Optionally, the nonconductive housing includes at least one aperture, and each of the plurality of differently configured terminal studs includes a common universal mounting base configured for one of press fit engagement or threaded engagement with the nonconductive housing when the universal mounting base is received in the aperture. The circuit breaker device may further include at least one of the selected ones of the plurality of separately provided and differently configured terminal studs removably attached to the housing. The circuit breaker device may further include a pair of selected ones of the plurality of separately provided and differently configured terminal studs removably attached to the housing. The pair of selected ones of the plurality of separately provided and differently configured terminal studs may be configured to be the same or may be configured differently from one another.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A circuit protection product comprising:
a nonconductive housing; and
a plurality of differently configured terminal studs;
wherein the nonconductive housing is configured to interchangeably accept all of the differently configured ones of the plurality of conductive terminal studs.

2. The circuit protection product of claim 1, wherein the plurality of conductive terminal studs includes a universal mounting base and a threaded portion projecting from the universal mounting base.

3. The circuit protection product of claim 1, wherein the nonconductive housing includes at least one aperture dimensioned to accept the universal mounting base after the nonconductive housing is formed.

4. The circuit protection product of claim 3, wherein the nonconductive housing is configured for threaded engagement with the universal mounting base.

5. The circuit protection product of claim 3, wherein the nonconductive housing is configured for press fit engagement with the universal mounting base.

6. The circuit protection product of claim 3, wherein the nonconductive housing includes a top surface and a bottom surface opposing one another, and wherein the at least one aperture is accessible from one of the top and bottom surfaces.

7. The circuit protection product of claim 3, wherein the nonconductive housing comprises a first terminal section, a second terminal section, and a circuit protection housing section between the first terminal section and the second terminal section.

8. The circuit protection product of claim 7, wherein the at least one aperture includes a first aperture located in the first terminal section and a second aperture located in the second terminal section.

9. The circuit protection product of claim 7, further comprising a circuit breaker assembly located in the circuit protection housing section.

10. The circuit protection product of claim 9, wherein the circuit breaker assembly includes a bistable element.

11. The circuit protection product of claim 10, wherein the circuit breaker assembly includes a trip element, the trip element extending external to the circuit protection housing section and operable by a user to deflect the bistable element.

12. The protection product of claim 10, wherein the circuit breaker assembly includes a reset element, the reset element extending external to the circuit protection housing section and operable by a user on an exterior surface of the circuit protector housing section to reset the bistable element.

13. A circuit breaker device comprising:
a nonconductive housing;
a circuit breaker assembly situated in at least portion of said housing; and
terminals for establishing an electrical connection through the circuit breaker assembly, wherein the terminals are separately provided from the nonconductive housing and include at least one universal mounting base receivable in an aperture in the housing and engageable to the housing with one of a press fitted engagement and a threaded engagement.

14. The circuit breaker device of claim 13, wherein the at least one universal mounting base is removable from the housing.

15. The circuit breaker device of claim 13, wherein the terminals include at least one threaded terminal portion extending from the universal mounting base.

16. The circuit breaker device of claim 15, wherein the terminals include a plurality of differently configured terminals each including a universally mounting base and a threaded terminal portion, the threaded terminal portions in each of the differently configured terminals including at least one of different diameters of the threaded terminal portions, differently configured threads in the threaded terminal portions, and different axial lengths in the threaded terminal portions.

17. The circuit breaker device of claim 13, wherein the nonconductive housing includes a top surface and a bottom surface opposing one another, and wherein the aperture in the housing is accessible from one of the top and bottom surfaces to receive the universal mounting base.

18. The circuit breaker device of claim 13, wherein the nonconductive housing comprises a first terminal section, a second terminal section, and a circuit protection housing section between the first terminal section and the second terminal section.

19. The circuit breaker device of claim 13, wherein the circuit breaker assembly includes a bistable element.

20. The circuit protection product of claim 19, wherein the circuit breaker assembly includes a trip element, the trip element operable by a user to deflect the bistable element.

21. The protection product of claim 19, wherein the circuit breaker assembly includes a reset element, the reset element operable by a user to reset the bistable element.

22. A circuit breaker device kit comprising:
at least one nonconductive housing including a circuit breaker assembly; and
a plurality of differently configured terminal studs, each of the plurality of differently configured terminal studs including a common universal mounting base configured for one of press fit engagement or threaded engagement with the nonconductive housing;
wherein the common universal mounting base provides interchangeable assembly of any of the plurality of differently configured terminal studs with the housing.

23. The circuit breaker device kit of claim 22, wherein the plurality of differently configured terminal studs are configured with at least one of different diameters, differently configured threads, and different axial lengths.

24. The circuit breaker device kit of claim 22, wherein the circuit breaker assembly is resettable.

25. The circuit breaker device kit of claim 22, wherein the circuit breaker assembly is manually trippable.

26. A circuit breaker device comprising:
a nonconductive housing including a circuit breaker assembly, wherein the nonconductive housing is configured for assembly with selected ones of a plurality of separately provided and differently configured terminal studs.

27. The circuit breaker device of claim 26, wherein the nonconductive housing includes at least one aperture, and each of the plurality of differently configured terminal studs includes a common universal mounting base configured for one of press fit engagement or threaded engagement with the nonconductive housing when the universal mounting base is received in the aperture.

28. The circuit breaker device of claim 27, further comprising at least one of the selected ones of the plurality of separately provided and differently configured terminal studs removably attached to the housing.

29. The circuit breaker device of claim 28, further comprising a pair of selected ones of the plurality of separately provided and differently configured terminal studs removably attached to the housing.

30. The circuit breaker device of claim 29, wherein the pair of selected ones of the plurality of separately provided and differently configured terminal studs are configured to be the same.

31. The circuit breaker device of claim 29, wherein the pair of selected ones of the plurality of separately provided and differently configured terminal studs are configured differently from one another.
